(19) United States
(12) Patent Application Publication
(10) Pub. No.: US 2008/0267524 A1
(43) Pub. Date: Oct. 30, 2008

(54) AUTOMATIC IMAGE ENHANCEMENT

(76) Inventors: Doron Shaked, Palo Alto, CA (US); Hila Nachlieli, Palo Alto, CA (US); Gennady Karvitsky, Palo Alto, CA (US); Shlomo Harush, Palo Alto, CA (US); Mary Nielsen, Palo Alto, CA (US); Aruna Kumar, Palo Alto, CA (US); Ingeborg Tasil, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,256

(22) Filed: Apr. 30, 2007

(51) Int. Cl. G06K 9/44

(52) U.S. Cl. 382/263

(57) ABSTRACT

This invention provides a method for automated image enhancement. Attribute measurements are extracted from a digital image and used for the generation of at least a noise threshold parameter, a sharpness parameter and a radicality parameter. The noise threshold parameter and sharpness parameter are evaluated to determine the degree of noise reduction and the degree of sharpening to be performed, collectively a determined enhancement. The determined enhancement is applied to derive a nominally enhanced image. With respect to the radicality parameter, the output image is the weighted average between the initial image and the nominally enhanced image.

### FIELD OF THE INVENTION

The present invention relates generally to the field of image analysis and image processing, and in particular to an improved system and method for automatic image enhancement.

### BACKGROUND

An old adage states that a picture is worth a thousand words. With the growing prevalence of computers, color printers and digital cameras, pictures are an increasingly common element in personal and professional communication.

Although film and photoprocessing is still a common way to provide pictures, photo editing and photofinishing is more commonly a digital process, where the original photograph is either scanned to provide a digital image, or is generated by a digital camera as a source digital image. Different uses of the image, e.g., Internet screen display, mailing advertisement or nature magazine, can and do impose different expectations upon the resulting image. In addition, digital cameras and digital scanners may be set to capture an image in a variety of different formats, e.g. *.raw, *.tif or *.jpg to name a few, which may impose different data structures for how the image data is represented, and consequently different limitations on how the photo might later be edited.

Digital images are also shared frequently by users over networks, and to accommodate bandwidth, storage and delivery time issues, frequently the image is compressed, resized, or changed from one format to another In addition image users may manually or automatically process images to enhance or otherwise modify them. All these activities may be unknown events to future viewers and users of the digital image. Further,

Whether rendered directly from a digital camera provided by a computer graphics engine, and/or provided by scanning a pre-existing image, a digital image is generally a representation of a two-dimensional image as a finite set of digital values. These digital values are more commonly known as picture elements or even more simply as pixels.

Digital photoprocessing typically involves at least two core actions, image analysis and image processing. Image analysis is a process by which the image is reviewed to determine a qualitative or quantitative image attribute. For example, image analysis may be used to determine whether an image is in or out of focus, too dark or too light, whether it is a natural image or a graphic image, and whether it should be softened or sharpened.

With at least some assessment of the image resulting from the image analysis, image processing can then be performed. Image processing is the process by which an imaging application or system alters the input image data. Image processing may be performed to change the color space of a digital image for a particular printing device. Image processing may also be performed to adjust the level of sharpness.

As digital images are indeed a data stream of digital information, random signal variations in the data stream are known as “noise.” The origins of noise may be many different sources and is usually of little consequence, though for example, when dealing with scanned images, noise is generally related to the granularity of the film or image that was scanned. Excessive levels of noise are objectionable to customers as the noise detracts from the overall intended image. Unfortunately, when performing sharpening upon a digital image, noise elements may inadvertently be increased and sharpened as well.

Although photoprocessing is a skill that is still manually performed, in many instances the need for volume processing or even the minimal amount of processing that is desired makes manual adjustment impractical. In other situations an operator may be unskilled in the art of photoprocessing, but is still in need of improving an image.

Although various attempts have been made to identify and impose sharpening and denoising processes, simple blind application is far from appropriate. In many instances, especially when attempting to use a linear-filtering process, sharpening and denoising undue each other's operation. Other solutions do exist which are based on a hard classification of neighborhoods of pixels corresponding to non-features (e.g., background, noise), and features (edges), Denoising filters are then applied to the non-feature neighborhoods and a separate sharpening filter is applied to the feature neighborhoods. Although such systems can be effective, they are computationally complex and thus require extensive computer resources. There is also a reasonable possibility for misclassification of pixel neighborhoods, especially as a result of noise.

Hence there is a need for an automatic image enhancement method and system that overcomes one or more of the drawbacks identified above.

### SUMMARY

The present disclosure advances the art by providing a method and system for automatic image enhancement.

In particular and by way of example only, according to an embodiment of the present invention, a method of automated image enhancement including: receiving a digital image; extracting a plurality of attribute measurements from the digital image; generating at least a noise threshold parameter, a sharpness parameter, and a radicality parameter based upon the extracted attribute measurements; evaluating the noise threshold parameter based on at least one attribute measurement to define the degree of noise reduction to be performed; evaluating the sharpness parameter based on at least one attribute measurement to define the degree of sharpening to be performed, the degree of noise reduction and the degree of sharpening collectively a determined enhancement for the digital image; evaluating the radicality parameter based on at least one attribute measurement to define the radicality of the determined enhancement to be performed; performing, with respect to the radicality of determined enhancement, a percentage of the determined degree of noise reduction and a percentage of the determined degree of sharpening to the received image.

### BRIEF DESCRIPTION OF THE DRAWINGS

FIG. 1 is a high level block diagram of an automatic image enhancement system in accordance with an embodiment;

FIG. 2 is a block diagram illustrating the operation of an automatic image enhancement system and method in accordance with an embodiment;

FIG. 3 is a further illustration of a part of a block operation shown in FIG. 2 in accordance with an embodiment;

FIG. 4 is a graph of the frequency response magnitude of high and low pass filters as used in attribute extraction in accordance with an embodiment;

FIG. 5 is a graph of a non-linear function used in a formula to provide a weighted average between an initial input image and a nominally enhanced image, in accordance with an embodiment;

FIG. 6 is a flow diagram for a method of automatic image enhancement in accordance with at least one embodiment; and

FIG. 7 is a block diagram of a computer system in accordance with one or more embodiments.

### DETAILED DESCRIPTION

Before proceeding with the detailed description, it is to be appreciated that the present teaching is by way of example, not by limitation. Thus, although the instrumentalities described herein are for the convenience of explanation shown and described with respect to exemplary embodiments, it will be appreciated that the principles herein may be equally applied in other types of automatic image enhancement.

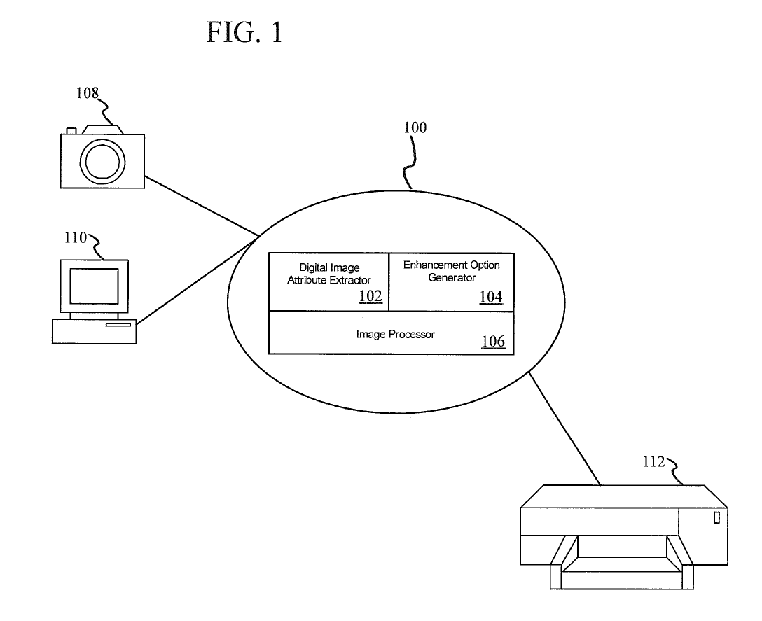

Now turning to the figures, FIG. 1 is a high level block diagram of an automatic image enhancement system “AIES” 100 in accordance with at least one embodiment. Moreover, AIES 100 is operable to perform a method of automated image enhancement in accordance with at least one embodiment.

As is further described below, AIES 100 is operable to automatically enhance digital images. The design of this method has been formed in accordance with the following basic tenants: A—Blurry images should probably be sharpened, however do not sharpen images that are already crisp and too much sharpening is usually excessive (even if the input image is very blurry). B—Sharpening enhances noise. For noisy images increase denoising. C—Strong sharpening with strong denoising does not produce natural looking images. D—Do not sharpen graphics. E—Be aware of JPG artifacts as they can be problematic when the image is sharpened. F—When an image is scaled up, the noise elements become more noticeable.

As shown, AIES 100 includes a digital image attribute extractor 102, an enhancement options generator 104, and an image processor 106. In at least one embodiment, these elements may be considered as modules of the system, e.g. digital image attribute extractor module 102, enhancement options generator module 104 and enhancement algorithm module also known as image processor module 106. In varying embodiments, each of these components may be subdivided and/or combined and the system may further include an input device 108, such as a camera alternatively input images may have been processed either manually or automatically, either by an analogue system or using a computer 110; and an output device 112, such as a printer.

It is further understood and appreciated that in at least one embodiment AIES 100 is implanted within a computer system as software or as hardware. For example, and with respect to the identification of the elements as modules, a module may be a piece of software code, a hardware device or a portion of a hardware device. During operation, AIES 100 may be maintained in active memory for enhanced speed and efficiency. In addition, it may also be operated within a computer network and may utilize distributed resources.

The digital image attribute extractor 102 is operable to receive a digital image and extract attribute measurements from the digital image. The extracted image measurements include at least a noise estimation and a sharpness estimation. The enhancement option generator 104 is operable to receive the extracted attribute measurements and based on these measurements, generates at least a noise threshold parameter, a sharpness parameter and a radicality parameter. The image processor 106 is in essence an enhancement algorithm that operates to enhance the provided image by applying sharpening and denoising filters in accordance with the noise threshold parameter and sharpness parameter. The degree of sharpening and denoising that is performed is determined by the radicality parameter.

More specifically, the noise threshold, Th, determines the local deviation level that will be smoothed in the image and it will be a high value in the case of strong noise. The sharpness parameter, λ, determines the extent of sharpness introduced to significant edges. The radicality parameter, R, is truly a unique and advantageous element for the automated image enhancement system and method. R determines how radical the enhancement should be. In at least one embodiment, where R=1, the sharpness and noise parameters are applied at their nominal values. When R=0, the sharpness and noise parameters are ignored and the output image is equal to the input image. Where 0<R<1, the output image is a weighted average between the input image and the nominally enhanced image.

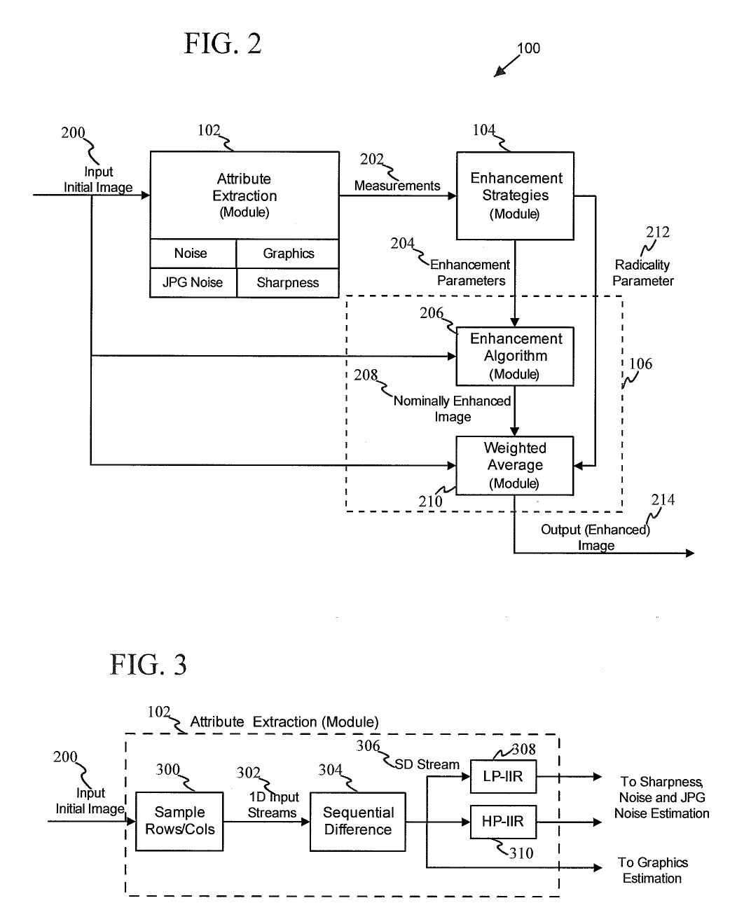

FIG. 2 provides a block flow diagram for the operation of AIES 100 in performing automated imaged enhancement in accordance with at least one embodiment. As shown, AIES 100 receives as input an initial digital image 200. In one embodiment the input initial image is a Joint Photographic Experts Group (JPEG) image. It should be appreciated that any form of image data, such as Tagged Image File Format (TIFF), Graphics Interchange Format (GIF), a bitmap, and/or other forms of image data may be used.

The provided initial image 200 is received by the attribute extraction module 202, which as the name suggests operates to extract a plurality of attributes. In at least one embodiment the extracted attribute measurements include a graphics estimation, a sharpness estimation, a noise estimation, and a JPG artifact estimation.

In at least one embodiment, the attribute measurement of noise estimation is as described in U.S. patent application Ser. No. 10/835,969 entitled “System and Method for Estimating Image Noise” and incorporated herein by reference. In at least one alternative embodiment, the attribute measurement of noise estimation is as described in U.S. patent application Ser. No. 11/388,152 entitled “Signal Noise Estimation” incorporated herein by reference. In at least one embodiment, the attribute measurement of image sharpness is as described in U.S. patent application Ser. No. 10/835,910 entitled “System and Method for Estimating Image Sharpness” incorporated herein by reference. Further, in at least one embodiment, the attribute measurement of JPG noise is as described in U.S. patent application Ser. No. 10/835,888 entitled “System and Method for Estimating Compression Noise in Images” incorporated herein by reference. It is understood and appreciated that other systems and methods of attribute measurement may be employed in different embodiments in addition to or in place of those cited above. These additions and/or substitutions are operator directed and do not depart from the intended scope of the automatic image enhancement system(s) and method(s) disclosed herein.

Although the above references provide complete detail, FIG. 3 provides a brief overview of the operation of a part of the attribute extraction module. Efficiency considerations are understood to be important for AIES 100. As such the input image is accessed once for several feature extraction purposes. In at least one embodiment, local frequency analysis is applied to derive most of the information requiring extensive computations. In an alternative embodiment frequency, content may be extracted locally using narrow band filters. Moreover, in at least one embodiment pixel values on rows and columns are filtered as data streams.

In one embodiment, the rows and columns are sampled, block 300 to determine sequential difference 304, for the sampled pixels. It is understood and appreciated that in alternative embodiments, color values, luminance value or other image values may be sampled in place of, or in addition to, luminance values. In one embodiment, image data from pixels of every Mth row and every Nth column is sampled, wherein M and N are positive integers. In one embodiment, M and N are equal. In another embodiment M and N are equal to 1 (e.g., the image is not sampled at all). The sequence of sampled image data is processed as a ID input stream 302 by filtering module 304 to provide sequential differences.

More specifically, for sequential difference processing every number in the ID Input Stream 302 is replaced by its difference from the number prior to it to provide SD Stream 306. The amount of zeros in the resulting sequence (e.g. SD Stream 306) is a strong indicator of whether the image is a graphics image or not. In addition, the sequential difference makes the typical frequency profile uniform providing for a more stable comparison of the different frequency bands.

As indicated by FIG. 3, in one embodiment a low pass filter 308 and a high pass filter 310 are utilized for filtering the SD Stream 306. In one embodiment, the high and low pass filters 308 and 310 are 6-tap Infinite Impulse Response (IIR) filters, however it is understood and appreciated that other appropriate filters may be employed. For each pixel the equation function for each filter in at least one embodiment is expressed as Equation 1:

$${Out}^{IIR} ( p ) = {\sum }_{i = 1}^{{N}_{a}} {α}_{i} \cdot {Out}^{IIR} ( p - i ) + {\sum }_{i = 0}^{{N}_{β}} {β}_{i} \cdot ln ( p - i )$$

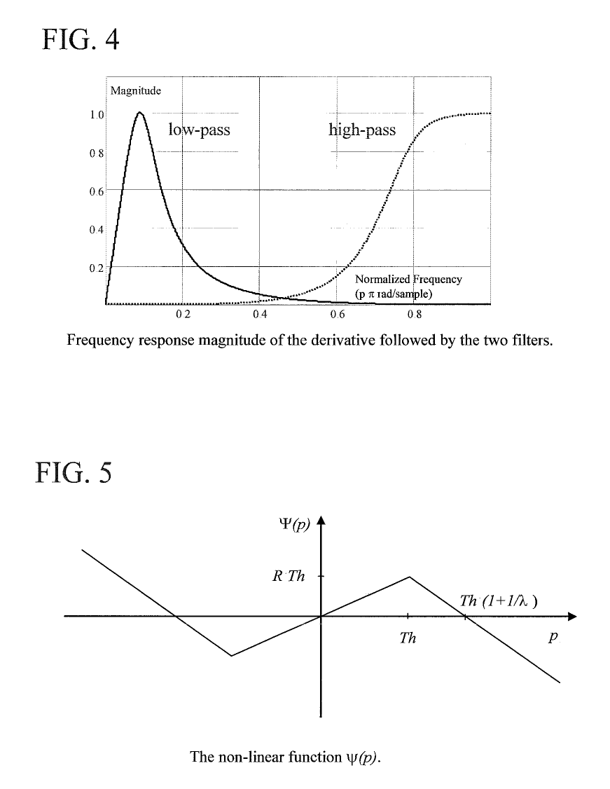

The application of low pass and high pass IIR filters to the SD Stream 306 results in two local frequency content descriptors LP(p) and HP(p), which are subsequently used for other attribute estimations. FIG. 4 depicts frequency response magnitudes of the derivative followed by the two filters. With respect to FIG. 4 it is appreciated that LP(p) as the low-pass filter of the difference is actually a band-pass filter.

Graphics Estimation: As a general rule it is undesirable to enhance graphics images, although enhancement of a graphic image having gradations and textures may be acceptable. Graphic images having constant colors are typically degraded. As noted above in the sequential difference processing the amount of zeros in the SD stream 306 is a strong indicator of whether the image should be considered as a graphic image or not. In at least one embodiment, if more than sixty-five percent (65%) of the differences are zero, the image is assumed to be a graphic image and is not to be enhanced.

Moreover, where the attribute measurements include a graphics estimation, and in response to a high graphics estimation, the radicality parameter is adjusted towards zero. When, as in the example above the estimation is over a user or system defined threshold, e.g., 65%, the radicality parameter is set to zero.

Noise Estimation: With many automated systems, the differentiation between noise and textured regions is poorly qualified. In at least one embodiment, AIES 100 and more specifically an embodiment of the employed method is established to identify regions of the image that are likely to be texture free, and to use a measure that will minimize interference of residual texture. Moreover smooth scene regions S are defined as regions with consistently low LP(p) activity, specifically the values of LP(p) in the smooth region and its V-vicinity are lower than a threshold Tₛₘ. In addition, highlights and shadows are excluded due to possible tone saturation, which might introduce textures into S. This is understood through Equation 2:

S={t|(G^{H}>In(t)>G^{L}) and {∀pε[t−V,t+V], LP(p)<Tₛₘ}}

The noise attribute is then estimated as the mean absolute high-pass content over S, as shown in Equation 3:

$${N}^{S} = {\int }_{p ∈ S}^{ } \vert HP ( p ) \vert d x$$

As residual textures, which will find their way into S are characterized by high values of HP(x), the noise estimation is advantageously more resilient then the trivial mean square measure as is the traditional approach.

Sharpness Estimation: Sharpness estimation can be difficult as sharpness perception is often affected by the nature of the scene as much as by the actual sharpness present in the image. For example, a relative comparison of sharpness in a dimly lit photo or portrait setting to a bright and textured outdoor scene is likely a difficult task. However, edges and edge profiles in images can be readily identified and serve quite well as a sharpness reference point.

In at least one embodiment, the sharpness estimation is performed with the LP(p) and HP(p) values as computed from Equation 1 above. Specifically, the sharpness estimation is realized with Equation 4:

$${Sh}^{F} = {\int }_{p ∈ F}^{ } {( \frac{HP ( p )}{LP ( p )} )}^{2} d p$$

Where the feature region is characterized by a threshold Tₛₕ on the local low-pass feature realized with Equation 5:

F={p|LP(p)>Tₛₕ}

JPG Artifact Estimation: The JPG format is a very common lossy compression method. The compression ratio is usually tuned to result in as few visible artifacts as possible. However, when enhanced, JPG artifacts that were below the visibility threshold tend to pop out in a very noticeable and displeasing way that generally results in an unsatisfactory image.

In at least one embodiment, JPG Artifact Estimation J, is accomplished by first computing the compression ratio C, where C=(W_{jpg}*H_{jpg})/FS_{jpg}, wherein W_{jpg}, H_{jpg} are the width and height of the JPG image, and FS_{jpg} is the JPG file size. An image activity A is determined as the mean absolute low pass response A=N^{Ω}, where N^{Ω} is defined as in Equation 3 above as N^{S}, with an average over the whole image domain S=Ω. The dpi of the image is represented as D. The estimation is then provided by Equation 6:

$$J = \frac{C \cdot \sqrt{A}}{D}$$

Returning to FIG. 2, with measurements 202 consisting of at least a noise estimation N and a sharpness estimation Sh, the process moves to the Enhancement Strategies Module 104. Simply stated, in at least one embodiment, the Enhancement Strategies Module 104 maps the attribute measurements as determined above to the preferred enhancement parameters of a noise threshold parameter Th, a sharpness parameter λ, and a radicality parameter R.

With respect to noise, sharpening tends to enhance noise as well. Therefore, for images that are estimated to be fairly noisy, application of a denoising filter is likely to be helpful. The noise parameter in at least one embodiment is expressed by Equation 7:

$$Th = \{ \begin{matrix} 4 \cdot {N}^{S} & {N}^{S} < 3 \\ 12 & 3 \leq {N}^{S}\end{matrix}$$

Moreover, in at least one embodiment, the noise threshold parameter Th is evaluated based on at least one attribute (e.g., the noise estimation) to define the degree of noise reduction to be performed. In other words, in at least one embodiment the noise estimation is mapped to the noise parameter to determine a first enhancement value.

With respect to sharpness, it is highly advantageous to permit sharpening of blurry images while at the same time being careful not to over sharpen. This concept is expressed in at least one embodiment by Equation 8:

$$λ = \{ \begin{matrix} 2.5 & {Sh}^{F} < 0.1 \\ 2.5 - 7.5 * ( {Sh}^{F} - 0.1 ) & 0.1 \leq {Sh}^{F} < 0.3 \\ 1 & 0.3 \leq {Sh}^{F}\end{matrix}$$

Moreover, in at least one embodiment, the sharpness parameter λ is evaluated based on at least one attribute (e.g., the sharpness estimation) to define the degree of noise reduction to be performed. As with the noise threshold Th, in at least one embodiment, the sharpness estimation is mapped to the sharpness parameter to determine a second enhancement value. Collectively, the degree of noise reduction and the degree of sharpening are a determined enhancement for the initial digital image.

As noted above, it is an advantageous aspect of the present invention to automatically enhance images, but to do so with an allegiance to the philosophy of do no harm. Indeed the system and method advantageously employ the determined enhancements with respect to radicality R. Again radicality R determines the relative weight of the enhancement in the output image. For R=0 the output image equals the input image (no harm is done, however there is no enhancement either). For R=1 the output image is the nominally enhanced image.

In at least one embodiment, radicality R is expressed as follows, with the first graph corresponding to the tenant not to enhance graphics and the second graph corresponding to the tenant not to apply strong sharpening with strong smoothing.

Internal uncertainty indicators may further reduce R in cases, such as when the noise estimation routine does not locate enough smooth regions to obtain a sufficiently good statistic. External uncertainty indicators may further reduce R in cases, such as when after looking at several representative images one notices that certain ranges of the indicators perform worse than other ranges, e.g. for a specific range of the noise estimate there are more mistakes than in another range, or alternatively, when it is noted that although the estimates are accurate, some ranges of e.g. noise or sharpness are indicative of infrequent failures of the enhancement algorithm. To accommodate for such operator perceived issues, in at least one embodiment R further includes an operator tunable element that may be adjusted so as to tune R. Moreover, in at least one embodiment in evaluating R a confidence evaluation of the noise threshold parameter and the sharpness parameter are performed. Where the confidence of the evaluation is low, R is adjusted towards a value of zero. Where the confidence of the evaluation is high, R may remain unchanged. In addition, JPG artifact estimation influences both R and Th, by altering N^{S}, specifically Equation 9:

$$( J > 1.5 ) ⇒ \{ \begin{matrix}{N}^{S} = max \{ {N}^{S} , 2.1 \} \\ R = min \{ R , 0.6 \}\end{matrix}$$

With respect to FIG. 2, it is appreciated that the enhancement parameters 204, e.g. the noise threshold parameter and sharpness parameter are passed to the enhancement algorithm module 206. At the enhancement algorithm module 206, variable denoising and sharpening filters are adjusted in accordance with the noise threshold parameter and sharpness parameter. In at least one embodiment the filtering is accomplished with a non-linear smoothing and sharpening algorithm based on bilateral filtering and generalized unsharp masking. In at least one embodiment this filtering is as described in U.S. patent application Ser. No. 10/833,435 entitled “Polynomial Approximation Based Image Filter Methods, System and Machine-Readable Media” incorporated herein by reference.

With the noise threshold parameter and sharpness parameter, and more specifically the determined enhancement value established, the input image 200 is filtered to provide a nominally enhanced image 208. As noted above, this nominally enhanced image 208 may not actually be acceptable by a human viewer, such as for example being an image that includes too much sharpening and too much denoising, or a graphic image to which sharpening has been applied. The present invention advantageously therefore acts to correct for such instances by moving to the weighted average module 210.

At the weighted average module 210, the radicality parameter R 212 is truly appreciated. Specifically, the action here is performed with respect to the radicality R to select a weighted average between the initial digital image 200 and the nominally enhanced image 208. In at least one embodiment, where R is about 1, the percentage of the performed determined enhancement that is accepted is about one hundred percent and the enhanced output image 214 is about the same as the nominally enhanced image 200. Where R is about 0, the percentage of the performed determined enhancement that is accepted is about zero and the enhanced output image 214 is about the same as the initial input image 200.

To aid in relating FIG. 2 to FIG. 1, a dotted line for the image processor 216 is shown to encompass the enhancement algorithm module 206 and the weighted average module 210. Indeed, it is understood and appreciated that in different configurations these elements could be otherwise combined or further segregated.

In at least one embodiment the nominally enhanced image 208 and the initial image 200 may be viewed as defining a range of possible enhancements for the provided initial image 200. It is of course understood and appreciated that it is not necessary to calculate each and every possible variation of the enhancement along the range between the initial image 200 and the nominally enhanced image 208. When viewed as a range, R then determines the percentage of the determined degree of denoising and the percentage of the determined degree of sharpening that is to be performed for a resulting enhanced image 214 that ranges from being the initial input image 200 to being the nominally enhanced image 208.

Moreover, for each pixel having a unique x and y coordinate, in at least one embodiment the image enhancement is understood and appreciated to be accomplished in accordance with the bilateral filter of Equation 10:

$$Out ( x , y ) = ln ( x , y ) + {\sum }_{ij} {K}_{ij} \cdot ψ ( ln ( x - i , y - j ) - ln ( x , y ) )$$

The radicality is evident with respect to Ψ(p) as defined in accordance with Equation 11:

$$ψ ( p ) = R \cdot \{ \begin{matrix} p & \vert p \vert < Th \\ sign ( p ) \cdot Th + λ \cdot ( Th - p ) & otherwise\end{matrix}$$

FIG. 5 provides a graph of the non-linear function Ψ(p).

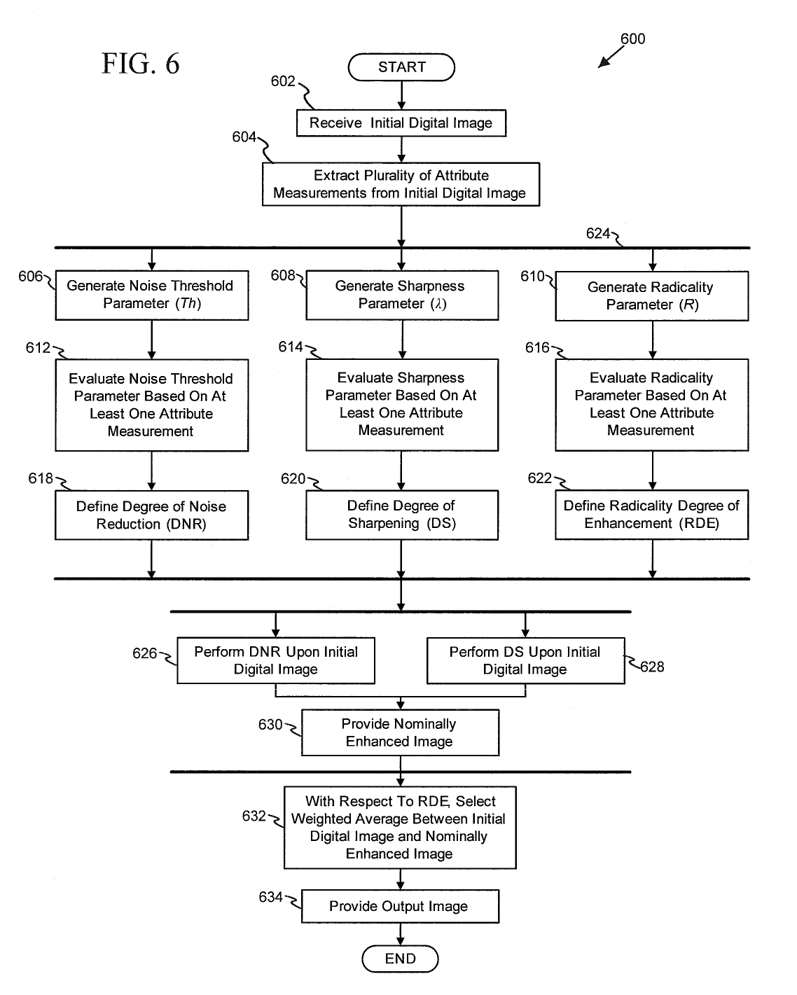

With respect to the above description of AIES 100 and the method of image enhancement, FIG. 6 is provided to summarize the method of image enhancement 600. It is understood and appreciated that the method 600 need not be provided in the precise order herein described, but that this flow of description and illustration are exemplary of but one embodiment.

As indicated in FIG. 6, in at least one embodiment, the method 600 of automatic image enhancement commences with the receipt of an initial digital image, block 602. A plurality of measurements are then extracted from the initial digital image, block 604. In at least one embodiment these extracted measurements include an estimation of noise and an estimation of sharpness. In at least one further embodiment these measurements further include an assessment of JPG noise and/or an assessment of the image as being a graphic. It is understood and appreciated that other measurements in addition to those listed may be extracted and or estimated as well.

With respect to at least the obtained noise estimation and sharpness estimation, the method proceeds to the generation of the key parameters of noise threshold (Th), block 606, sharpness (λ), block 608 and radicality (R), block 610. The noise threshold parameter is then evaluated based on at least one attribute measurement, block 612, the attribute being in at least one embodiment the noise estimation. The sharpness parameters is likewise evaluated based on at least one attribute measurement, block 614, the attribute being in at least one embodiment the sharpness estimation, The radicality parameter is also evaluated, block 616, and in at least one embodiment this is a confidence evaluation of the noise and/or sharpness parameters. Indeed, as described above with respect to the processing of a sequential stream a high percentage of zeros is likely to indicate the initial image as being a graphic, therefore an evaluation of R towards the value of 0.

Based upon the determined noise threshold parameter, a defined degree of noise reduction (DNR) is established, block 618. Similarly, a defined degree of sharpening is established, block 620, as is a defined radicality degree of enhancement, block 622. In at least one embodiment the defined degree of radicality is a weighting factor that will be used subsequently to determine the weighted average between the initial digital image and the nominally enhanced image. As indicated by the dark parallel lines 624, the generation of parameters and the definitions of degree are actions that in at least one embodiment are performed substantially contemporaneously.

Having determined the degree of noise reduction and the degree of sharpening, in at least one embodiment variable noise and sharpening filters are correspondingly adjusted. With the filter so adjusted, the degree of noise filtering is performed upon the initial image, block 626. Likewise the degree of sharpening is also performed upon the initial image, block 628. Although illustrated as separate actions, in at least one embodiment the sharpening and denoising operations of blocks 626 and 628 are performed as a combined action. In at least one alternative embodiment, the actions are performed separately. In either case, the result is to provide a nominally enhanced image, as in block 630.

With respect to the radicality degree of enhancement, R, the weighted average between the initial image and the nominally enhanced image is then selected, block 632, and the output image is provided, block 634, Where R has a value of about 1 the provided output image is about the nominally enhanced image. Where R has a value of about 0, the provided output image is about the initial digital image.

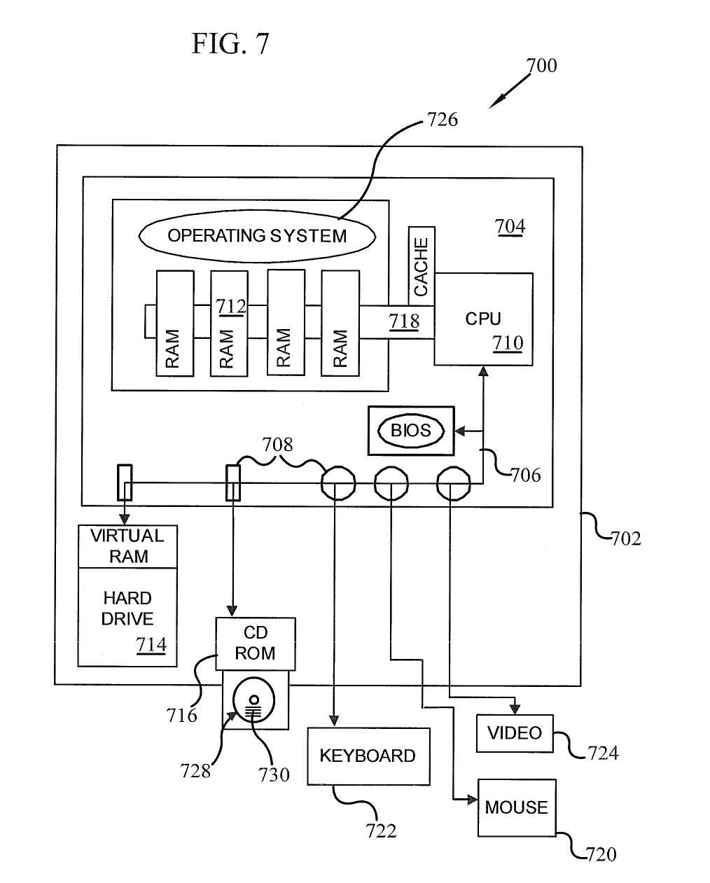

As stated above, in at least one embodiment, AIES 100 is implemented as a computer system for automatically enhancing images. FIG. 7 is a high level block diagram of an exemplary computer system 700. Computer system 700 has a case 702, enclosing a main board 704. The main board has a system bus 706, connection ports 708, a processing unit, such as Central Processing Unit (CPU) 710, and a memory storage device, such as main memory 712, hard drive 714, and CD/DVD Rom drive 716.

Memory bus 718 couples main memory 712 to CPU 710. A system bus 706 couples hard drive 714, CD/DVD Rom drive 716, and connection ports 708 to CPU 710. Multiple input devices may be provided, such as for example a mouse 720 and keyboard 722. Multiple output devices may also be provided, such as for example a video monitor 724 and a printer (not shown).

Computer system 700 may be a commercially available system, such as a desktop workstation unit provided by HP, or other computer system provider. Computer system 700 may also be a networked computer system, wherein memory storage components such as hard drive 714, additional CPUs 710 and output devices such as printers are provided by physically separate computer systems commonly tied together in the network. Those skilled in the art will understand and appreciate that physical composition of components and component interconnections comprising computer system 700, and select a computer system 700 suitable for the schedules to be established and maintained.

When computer system 700 is activated, preferably an operating system 726 will load into main memory 712 as part of the boot strap startup sequence and ready the computer system 700 for operation. At the simplest level, and in the most general sense, the tasks of an operating system fall into specific categories—process management, device management (including application and user interface management) and memory management.

In such a computer system 700, the CPU 710 is operable to perform one or more of the scheduling embodiments described above. Those skilled in the art will understand that a computer-readable medium 728 on which is a computer program 730 for adding activities to a schedule may be provided to the computer system 700. The form of the medium 728 and language of the program 730 are understood to be appropriate for computer system 700. Utilizing the memory stores, such as for example one or more hard drives 714 and main system memory 712, the operable CPU 702 will read the instructions provided by the computer program 730 and operate to perform the automatic image enhancement system and/or method as described above.

Changes may be made in the above methods, systems and structures without departing from the scope thereof. It should thus be noted that the matter contained in the above description and/or shown in the accompanying drawings should be interpreted as illustrative and not in a limiting sense. The following claims address all generic and specific features described herein, as well as all statements of the scope of the present method, system and structure, which, as a matter of language, might be said to fall therebetween.

What is claimed is:

1. A method of automated image enhancement comprising:
receiving a digital image;
extracting a plurality of attribute measurements from the digital image;
generating at least a noise threshold parameter, a sharpness parameter, and a radicality parameter based upon the extracted attribute measurements;
evaluating the noise threshold parameter based on at least one attribute measurement to define the degree of noise reduction to be performed;
evaluating the sharpness parameter based on at least one attribute measurement to define the degree of sharpening to be performed, the degree of noise reduction and the degree of sharpening collectively constitute a determined enhancement for the digital image;
evaluating the radicality parameter based on at least one attribute measurement to define the radicality of the determined enhancement to be performed; and
performing, with respect to the radicality of determined enhancement, a percentage of the determined degree of noise reduction and a percentage of the determined degree of sharpening to the received digital image.

2. The automated image enhancement method of claim 1, wherein the attribute measurements include a graphics estimation, a sharpness estimation, a noise estimation, and a JPG artifact estimation.

3. The automated image enhancement method of claim 1, wherein:
for evaluating the noise threshold parameter the associated attribute is a noise estimation;
for evaluating the sharpness parameter the associated attribute is a sharpness estimation; and
for evaluating the radicality parameter the associated attribute is a confidence evaluation of the noise parameter and/or of the sharpness parameter.

4. The automated image enhancement method of claim 1, wherein for a radicality parameter of about 1, the percentage of performed determined enhancement is about 100.

5. The automated image enhancement method of claim 1, wherein for a radicality parameter of about 0, the percentage of performed determined enhancement is about 0.

6. The automated image enhancement method of claim 1, wherein evaluation of the radicality parameter includes evaluation of a operator adjustable element provided by an operator to tune the radicality parameter.

7. The automated image enhancement method of claim 6, wherein for a low confidence evaluation the radicality parameter is adjusted towards 0.

8. The automated image enhancement method of claim 1, wherein the sharpening and noise reduction is performed substantially contemporaneously.

9. The automated image enhancement method of claim 1, wherein the attribute measurements include a graphics estimation, and in response to a high graphics estimation the radicality parameter being adjusted towards 0.

10. The automated image enhancement method of claim 1, wherein the method is stored on a computer-readable medium as a computer program which, when executed by a computer will perform the steps of automatic image enhancement.

11. A method of automated image enhancement comprising:
receiving a digital image;
extracting a plurality of attribute measurements from the digital image, the attribute measurements including at least a noise estimation and a sharpness estimation;
generating at least a noise threshold parameter, a sharpness parameter, and a radicality parameter based upon the extracted attribute measurements;
mapping the noise estimation to the noise parameter to determine a first enhancement value;
mapping the sharpness estimation to the sharpness parameter to determine a second enhancement value;
evaluating the radically parameter to determine a weighting factor;
adjusting a variable denoising filter to apply noise filtering to the digital image, the amount of noise filtering corresponding to the first enhancement value;
adjusting a variable sharpening filter to apply sharpening to the digital image, the amount of sharpening corresponding to the second enhancement value;
filtering the digital image through the adjusted denoising filter and adjusted sharpening filter to provide a first enhanced image; and
with respect to the weighting factor, selecting the weighted average between the digital image and the first enhanced image to provide an enhanced image.

12. The automated image enhancement method of claim 11, wherein a radicality parameter of about 1, the determined weighting factor results in the selection of about the first enhanced image.

13. The automated image enhancement method of claim 11, wherein a radicality parameter of about 0, the determined weighting factor results in the selection of about the digital image.

14. The automated image enhancement method of claim 11, wherein the attribute measurements include a graphics estimation, and in response to a high graphics estimation the radicality parameter being adjusted towards 0.

15. The automated image enhancement method of claim 11, wherein evaluation of the radicality parameter includes a confidence evaluation of the noise threshold parameter and a sharpness parameter.

16. The automated image enhancement method of claim 15, wherein for a low confidence evaluation the radicality parameter is adjusted towards 0.

17. The automated image enhancement method of claim 11, wherein the method is stored on a computer-readable medium as a computer program which, when executed by a computer will perform the steps of automatic image enhancement.

18. An automated image enhancement system comprising:
a digital image attribute extractor, operable to receive a digital image and extract attribute measurements from the digital image, the attribute measurements including at least a noise estimation and a sharpness estimation;
a enhancement option generator, operable to receive the extracted attribute measurements and generate at least a noise threshold parameter defining a degree of noise reduction, a sharpness parameter defining a degree of sharpness reduction, and a radicality parameter based upon the extracted attribute measurements, the degree of noise reduction and the degree of sharpness collectively a determined enhancement; and
a image enhancer, operable to receive the digital image, the determined enhancement and the radicality parameter, the image enhancer further operable in accordance with a formula to provide an output image corresponding to the weighted average between the initial digital image and a nominally enhanced image provided by the determined enhancement.

19. The automated image enhancement system of claim 18, wherein for a first instance of a radicality parameter of about 1, the weighting factor of the radicality results in an output image of about the nominally enhanced image, and for a second instance of a radicality parameter of about 0, the weighting factor of the radicality results in an output image of about the initial digital image.

20. The automated image enhancement system of claim 18, wherein evaluation of the radicality parameter includes a confidence evaluation of the noise threshold parameter and the sharpness parameter, and for a low confidence evaluation the radicality parameter is adjusted towards 0.
